(19) United States
(12) Patent Application Publication
(10) Pub. No.: US 2021/0410231 A1
(43) Pub. Date: Dec. 30, 2021

(54) HEATER

(71) Applicant: Shenzhen Eigate Technology Co., Ltd., Shenzhen (CN)

(72) Inventor: Tuanfang LIU, Shenzhen (CN)

(21) Appl. No.: 17/129,798

(22) Filed: Dec. 21, 2020

(30) Foreign Application Priority Data
Jun. 29, 2020 (CN) 202010605465.5
Jun. 29, 2020 (CN) 202021227111.3

(51) Int. Cl. H05B 3/16; A24F 40/46

(52) U.S. Cl. CPC H05B 3/16; A24F 40/10; A24F 40/46

(57) ABSTRACT

A heater includes a ceramic core and a metal wire secured to the ceramic core. The ceramic core includes four through holes.

### CROSS-REFERENCE TO RELAYED APPLICATIONS

Pursuant to 35 U.S.C. § 119 and the Paris Convention Treaty, this application claims foreign priority to Chinese Patent Application No. 202010605465.5 filed on Jun. 29, 2020, and to Chinese Patent Application No. 202021227111.3 filed on Jun. 29, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a heater.

Conventionally, a heater comprises a ceramic core comprising one or two through holes, and thus one or two metal wires are disposed in the one or two through holes. The design limits the output power of the heater, and the heater can only produce a small amount of heat and little vapor.

### SUMMARY

The disclosure provides a heater comprising a ceramic core and a metal wire secured to the ceramic core. The ceramic core comprises four through holes.

In a class of this embodiment, the metal wire comprises a first part coiled into a spiral disposed in one of the four through holes, and a second part extending out of the ceramic core to form a pin.

In a class of this embodiment, the heater comprises four metal wires; the four metal wires each are coiled into the spiral and are disposed in the four through holes, respectively; each metal wire comprises two pins; and the four metal wires are parallel-connected to each other.

In a class of this embodiment, the four through holes are cylindrical, and the four metal wires each are coiled into a cylindrical spiral.

In a class of this embodiment, the ceramic core is cylindrical.

### BRIEF DESCRIPTION OF THE DRAWINGS

FIG. 1 is a schematic diagram of a heater in accordance with one embodiment of the disclosure;

FIG. 2 is another schematic diagram of a heater in accordance with one embodiment of the disclosure; and

FIG. 3 is a sectional view of a heater in accordance with one embodiment of the disclosure.

### DETAILED DESCRIPTION

To further illustrate, embodiments detailing a heater are described below. It should be noted that the following embodiments are intended to describe and not to limit the disclosure.

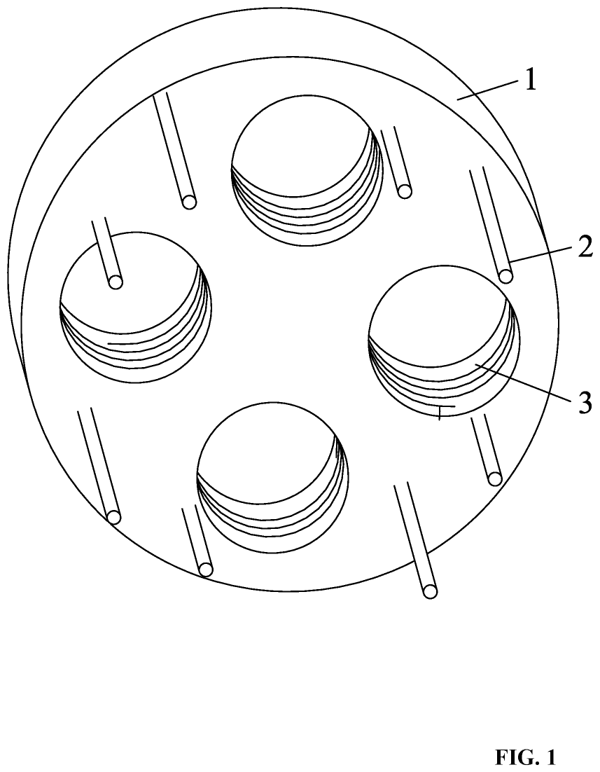

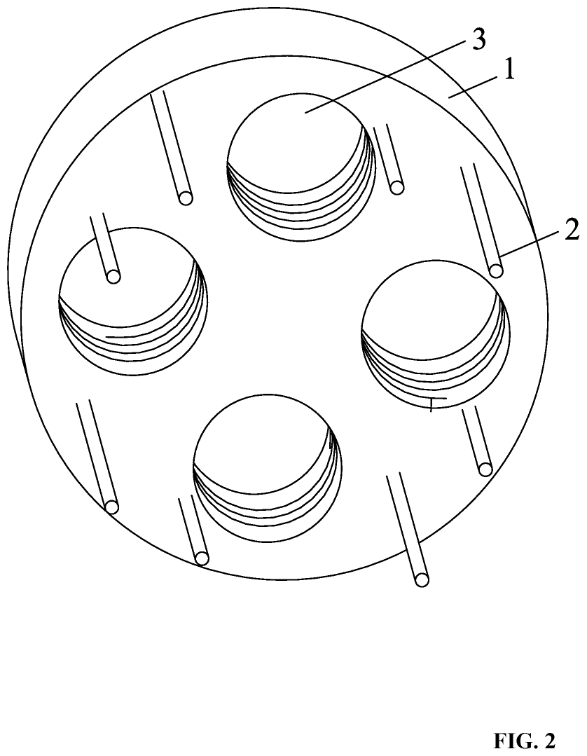

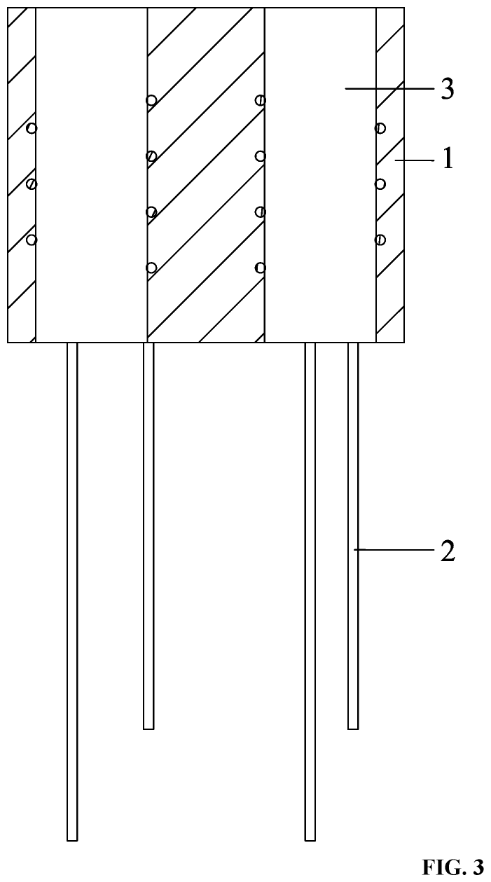

As shown in FIGS. 1-3, the disclosure provides a heater comprising a ceramic core 1 and a metal wire 2 secured to the ceramic core. The ceramic core comprises four through holes 3. When current is flowing through the metal wire, the metal wire is heated. In certain embodiments, the heater comprises four metal wires. The four metal wires each comprise a first part coiled into a spiral disposed in one of the four through holes, and a second part extending out of the ceramic core 1 to act as a pin. In certain embodiments, each metal wire comprises two pins. The positive terminals of the pins of the four metal wires are connected to each other, and the negative terminals thereof are connected to each other, to form a parallel structure. When current is flowing through the four metal wires, the four metal wires are heated. The heat is transferred to the ceramic core to heat the e-liquid to produce vapor.

In certain embodiments, the ceramic core is replaced by quartz, crystal, mica, jade or other materials. The ceramic core is a cuboid. cube, or polygon. The four though holes of the ceramic core are square, oval, or a combination thereof. The metal wires in the through holes includes but is not limited to a cylindrical spiral.

The following advantages are associated with the heater of the disclosure:

1. The ceramic core is a cylinder comprising four through holes, which is convenient to manufacture. The four metal wires are connected in parallel, so that the heater has a long service life, high output power and can produce much vapor. The heater is compatible with a variety of e-liquid, with fast temperature rise, and no e-liquid splashes in the heating process.

2. The ceramic core comprises four through holes. The four through holes is not easily completely blocked by the precipitate of the e-liquid even for a long time of use, thus extending the service life of the heater.

It will be obvious to those skilled in the art that changes and modifications may be made, and therefore, the aim in the appended claims is to cover all such changes and modifications.

What is claimed is:

1. A heater, comprising a ceramic core and a metal wire secured to the ceramic core, wherein the ceramic core comprises four through holes.

2. The heater of claim 1, wherein the metal wire comprises a first part coiled into a spiral disposed in one of the four through holes, and a second part extending out of the ceramic core to form a pin.

3. The heater of claim 2, comprising four metal wires; wherein the four metal wires each are coiled into the spiral and are disposed in the four through holes, respectively; each metal wire comprises two pins; and the four metal wires are parallel-connected to each other.

4. The heater of claim 3, wherein the four through holes are cylindrical, and the four metal wires each are coiled into a cylindrical spiral.

5. The heater of claim 4, wherein the ceramic core is cylindrical.
